(19) United States
(12) Patent Application Publication
(10) Pub. No.: US 2026/0361442 A1
(43) Pub. Date: Nov. 12, 2026

(54) FREE-SPACE OPTICAL BEAM MULTIPLEXING SYSTEM AND ASSOCIATED METHOD

(71) Applicant: BERTIN TECHNOLOGIES, Montigny-Le-Bretonneux (FR)

(72) Inventors: Régis GRASSER, Gardanne (FR); Marco CASALE, Aix-en-Provence (FR)

(73) Assignee: BERTIN TECHNOLOGIES, Montigny-Le-Bretonneux (FR)

(21) Appl. No.: 19/486,742

(22) PCT Filed: May 16, 2024
(86) PCT No.: PCT/EP2024/063464

§ 371 Date: Nov. 21, 2025

(30) Foreign Application Priority Data
May 24, 2023 (FR) FR2305150

(51) Int. Cl. H04J 14/02; G02B 6/293; H04B 10/118; H04J 14/00

(52) U.S. Cl. CPC H04J 14/0307; G02B 6/29302; G02B 6/29305; G02B 6/2938; H04B 10/118; H04J 14/05

(57) ABSTRACT

The invention relates to a free-space multiplexing system (1) of polarized light beams (10) for the transmission of a multiplexed beam (12) in free space, comprising a plurality of optical multiplexing devices (11) on at least two stages (11a), and wherein, for at least one interleaving stage (11b), at least one multiplexing device (11) comprises an interleaving device (110) comprising an angle-invariant optical combination module (113) configured to combine incoming beams (10a, 10b) of distinct polarization, in order to form an outgoing beam (10c) of mixed polarization, and an optical transformation module (111) configured to modify the polarization of the outgoing beam 10c in order to for a multiplexed beam (12a) of the same polarization.

### TECHNICAL FIELD

The present invention relates to the field of free-space optical beam multiplexing systems, for the transmission of a multiplexed beam in free space. It finds particularly advantageous application the field of spatial optical telecommunication terminals.

### PRIOR ART

In the field of spatial optical telecommunications, there is on-board equipment on spatial optical telecommunications terminals for transporting a data stream to Earth or to other satellites in the same orbit or a different orbit. A distinction is particularly made between low Earth orbit (LEO), medium Earth orbit (MEO), and geostationary orbit (GEO). In the case of a data stream sent from a satellite 3 to Earth 30, the term downward signals, as illustrated by the arrow F1 in FIG. 1, is used, differentiated from upward signals coming from Earth 30 (illustrated by the arrow F2).

Typically, the emission signal on board a spatial optical terminal is delivered by several series of fibers, each series comprising several polarized light beams comprising different wavelengths. Each fiber series can, for example, transport the same wavelengths but with different polarization states and different coded information.

A multiplexing system is used in order to combine the beams into a multiplexed beam to be transmitted in free space via a telescope.

The optical power transported by the different beams does not allow the use of conventional fiber components used for terrestrial applications. Indeed, due to the power required for the transmission of these signals, spatial applications generally use beams of greater dimensions than terrestrial telecommunication standards (the latter being typically about 300 μm in diameter).

The multiplexing function is therefore constructed in free space. The techniques currently used in the spatial field comprise dichroic filters. Used with an incidence of typically 45 degrees, dichroic filters reflect part of the spectrum and transmit the rest. It is thus possible to combine different wavelengths together. FIG. 2A illustrates, by way of example, multiplexing of six wavelengths λ₁ to λ₆ and two polarizations combined by a multiplexing system 1′ comprising dichroic filters 112.

However, this dichroic filter combination technology encounters several limitations. FIG. 2B illustrates, by way of example, the spectral response R₁₁₂ of a dichroic filter 112. The response R₁₁₂ of the dichroic filter comprises a transition zone Δ_{λ}′ around the wavelengths for example λ₁, λ₂ to be transmitted or reflected. The signal is divided in this transition zone Δ_{λ}′ and combination cannot be effective in this zone. Besides a spacing Δ_{λ}, used to separate the wavelengths clearly (for example, Δ_{λ}=175 GHz for a bandwidth of 84 GHz), it is therefore necessary to retain empty zones in the spectral band to accommodate this transition zone Δ_{λ}′. The available bandwidth is therefore significantly reduced.

Furthermore, this transition zone Δ_{λ}′ is not temperature-stable with typically a sensitivity of about 1.5 GHz/°C. Even under optimal conditions, it is not possible to reduce this transition zone to less than 300 GHz when accounting for manufacturing, position and angle adjustment, and thermal and mechanical stress contingencies.

When the number of wavelengths to be multiplexed increases, dichroic filter technology encounters another problem. The architecture of the multiplexing system becomes increasingly complex and is not spatially modular. This technology is furthermore very sensitive in the angular positioning of the filters. In addition, empty spectral zones must be taken into account to manage the transition zones of the filters. The C-band (1530-1565 nm), for example, is rapidly saturated.

Document US2018270010 A1 describes a multiplexing system for free-space communication by a telescope. This system D3 implements fiber multiplexing between a first group of wavelengths having a first polarization and a second group having a different second polarization, combined by a polarization combiner. In free space, the multiplexed beams are combined by a single dichroic filter stage. However, for a high-power beam transmission by a telescope, fiber multiplexing induces non-linear coupling between the channels due to the excessive power of the beams. The information is therefore mixed.

One object of the present invention is therefore to provide an enhanced solution for multiplexing at least four light beams for the transmission of a light beam in free space. More particularly, the invention provides a reliable and robust multiplexing solution for a substantial number of light beams to be multiplexed for their transmission by a telescope, and particularly for spatial optical telecommunication.

The other objects, features and advantages of the present invention will be clear after an examination of the following description and the accompanying drawings. It is understood that other advantages can be incorporated.

### SUMMARY

To achieve this objective, according to one aspect, a free-space multiplexing system of at least four polarized light beams is provided for the transmission of a multiplexed beam in free space, preferably toward a telescope. This system is particularly compatible with the transmission of a high-power multiplexed beam in free space. Advantageously, the system comprises a plurality of optical multiplexing devices arranged in at least two successive stages in order to successively combine said polarized light beams pairwise. For at least one stage, referred to as “interleaving stage,” at least one multiplexing device comprises an interleaving device configured to receive a first incoming beam having at least a first wavelength and a second incoming beam having at least a second wavelength, distinct from the at least a first wavelength, the first incoming beam and the second incoming beam having mutually distinct polarizations, and the interleaving device comprising:
an angle-invariant combination optical module configured to combine the first and second incoming beams so as to form an outgoing beam of mixed polarization,
an optical transformation module configured to receive the outgoing beam, the transformation module being configured so as to modify the polarization of one among the at least a first wavelength and the at least a second wavelength, so as to form a multiplexed beam wherein the at least a first and at least a second wavelengths have the same polarization.

Thus, the system makes it possible to multiplex, by interleaving, different wavelengths from beams of distinct polarization. There is as such no longer a transition zone like for existing solutions based on dichroic filters. It is therefore possible to combine wavelengths that are very close to each other by maximizing the bandwidth. This is therefore particularly adapted for the combined transmission of a large number of light beams, and particularly for multiplexing at least four light beams.

The interleaving stage comprising an angle-invariant optical combination module, the combination of the first and second incoming beams is performed robustly in terms of positioning and thermal stability. Particularly for high-altitude applications and for space terminals, multiplexing systems face significant thermal variations and substantial mechanical stress. Thanks to angle invariance, any difference in orientation of the combination module, due to thermal and/or mechanical stress does not result in a significant deviation in the orientation of the outgoing combined beam. The tolerance of the multiplexing system to an adjustment fault is furthermore enhanced, particularly relative to techniques only implementing dichroic filters.

This is particularly advantageous for free-space emission of high-power signals, the reception of which is highly sensitive to angular offset or “misalignment” phenomena. For transmissions over long distances, good angular precision is required to ensure correct reception of the transmitted beam. This is particularly the case for high-altitude and space applications.

Synergistically, the multiplexing system therefore allows reliable and robust multiplexing for a substantial number of light beams, and particularly for at least four light beams to be multiplexed. The bandwidth is furthermore optimized.

Using at least one interleaving stage also makes it possible to simplify the architecture of the free-space multiplexing system, to facilitate its implementation in high-altitude terminals, and particularly space terminals.

The multiplexing system is thus particularly adapted for links between LEO orbits and the ground, MEO and the ground, GEO and the ground, but also between satellites in the same orbit or in different LEO, MEO, or GEO orbits.

A second aspect relates to a telescope emission assembly comprising the multiplexing system described according to the first aspect, and a telescope. The emission assembly thus has the effects and advantages of the multiplexing system. According to one example, the assembly is configured to transmit the multiplexed beam output from the multiplexing system in free space to the telescope. Preferably, the telescope is a space satellite telescope. The emission assembly is thus particularly adapted for links between LEO orbits and the ground, MEO and the ground, GEO and the ground, but also between satellites in the same orbit or in different LEO, MEO, or GEO orbits.

A third aspect relates to a free-space multiplexing method for the transmission of a beam in free space, comprising:
receiving at least four polarized light beams in free space,
passing said light beams in a multiplexing system comprising a plurality of optical multiplexing devices arranged in at least two successive stages, so as to successively combine said light beams pairwise, at least one multiplexing device of at least one stage, referred to as “interleaving stage”, comprising an interleaving device comprising an optical transformation module and an angle-invariant optical combination module, such that:
a first incoming beam, having at least a first wavelength, and a second incoming beam, having at least a second wavelength distinct from the at least a first wavelength, the first incoming beam and the second incoming beams having mutually distinct polarizations, are received and combined by the optical combination module, so as to form an outgoing beam of mixed polarization,
the outgoing beam is received by the optical transformation module, and the polarization of one among the at least a first wavelength and at least a second wavelength is modified by the transformation module, so as to form a multiplexed beam of homogeneous polarization, i.e. wherein the at least a first wavelength and at least a second wavelength have the same polarization.

Preferably, the multiplexed beam is transmitted in free space by a telescope. For this purpose, the method may comprise a transfer in free space and to a telescope of the multiplexed beam output from the multiplexing system, the multiplexed beam preferably having a diameter greater than or equal to 0.5 mm.

The multiplexing system of the method according to this aspect may more particularly be the multiplexing system according to the first aspect. On account of the features of the multiplexing system, the effects and advantages described above, it is understood that the multiplexing method allows reliable and robust multiplexing for a substantial number of light beams to be multiplexed, and particularly for at least four light beams to be multiplexed. The bandwidth is furthermore optimized.

The multiplexing method is thus particularly adapted for links between LEO orbits and the ground, MEO and the ground, GEO and the ground, but also between satellites in the same orbit or in different LEO, MEO, or GEO orbits.

### BRIEF DESCRIPTION OF THE DRAWINGS

The purposes, objects, characteristics and advantages of the invention will be more apparent from the detailed description of one embodiment thereof which is illustrated by the following accompanying drawings wherein:

FIG. 1 shows a schematic view of a data stream transport between Earth and a satellite.

FIG. 2A shows a diagram of an existing multiplexing technique implementing dichroic filters.

FIG. 2B shows a wavelength response diagram of a dichroic filter.

FIG. 3 shows a general view of the emission assembly comprising the multiplexing system, according to an exemplary embodiment.

FIG. 4A schematically shows the principle of a combination of light beams by interleaving, according to one example.

FIG. 4B shows a wavelength response of an interleaving device according to the principle illustrated in FIG. 4A.

FIGS. 5 to 10 show the multiplexing system according to several exemplary embodiments.

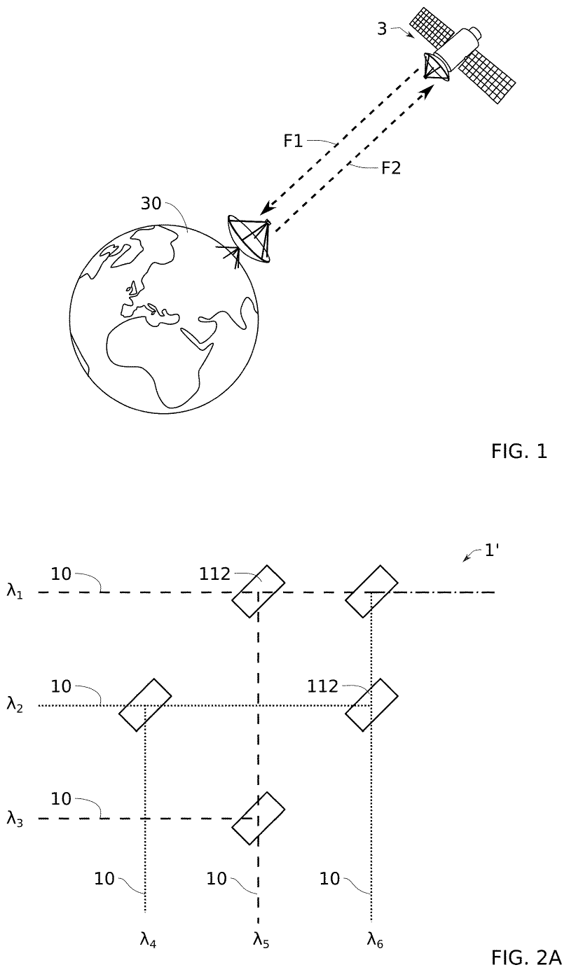

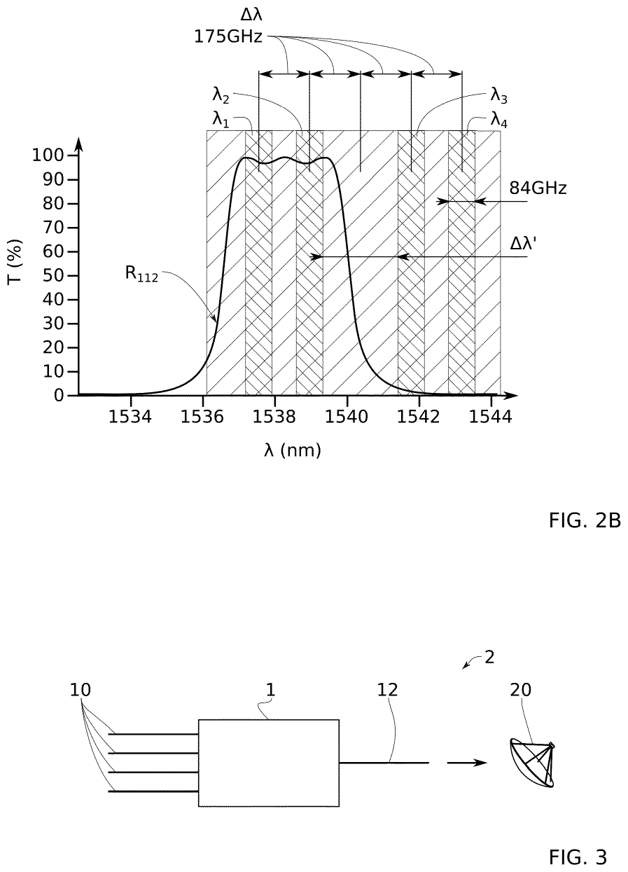

The drawings are given as examples and do not limit the invention. They constitute schematic representations intended to facilitate understanding of the invention and are not necessarily plotted to the scale of practical applications. In particular, the relative dimensions of the elements illustrated are not necessarily representative of reality.

### DETAILED DESCRIPTION

Before undertaking a detailed review of embodiments of the invention, optional features of the different aspects of the invention are listed below that can optionally be used in combination or alternatively.

According to one example, the system is configured to transmit the multiplexed beam in free space to the telescope. The multiplexed beam can be transmitted in free space from the multiplexing system to the telescope.

According to one example, the multiplexing devices are configured such that the successive combinations of light beams by the at least two stages are performed in free space.

According to one example, each multiplexing device of an interleaving stage is an interleaving device.

According to one example, the first optical transformation module is a birefringent module. Thus, the optical transformation module is also angle-invariant. The robustness of the system in terms of positioning and thermal stability is thus further enhanced, along with its adjustment fault tolerance. According to one example, the optical transformation module comprises birefringent crystals.

According to one example, the angle-invariant combination module comprises a first surface and a second surface parallel to each other, the first surface being configured to reflect the first incoming beam and the second surface being configured to reflect the first incoming beam resulting from the reflection on the first surface, and allow the second incoming beam to pass so as to combine them. The parallelism between the two surfaces of the combination module makes it possible to obtain angle invariance. This makes it possible to transfer the need for precision to the manufacture of the combination module for obtaining parallel surfaces, rather than to the positioning of the combination module as would be the case for a non-angle-invariant module. According to one example, the combination module is an optical rhombohedron.

According to one example, the optical multiplexing devices are configured to act on beams in the order of a millimeter in diameter, and more particularly beams greater than or equal to 0.5 mm, preferably between 0.5 mm and 20 mm, in diameter.

According to one example, the optical beam output from the multiplexing system is a high-power beam. According to one example, the optical beam output from the multiplexing system has a power between 1 W and 1000 W, preferably between 5 W and 1000 W.

According to one example, the multiplexing system comprises at least two, and preferably at least three, successive interleaving stages. The effects and advantages of the interleaving stage described above are thus obtained for the plurality of beams combined by interleaving by these stages. The system is thus further enhanced for multiplexing a substantial number of light beams.

According to one example, the multiplexing system comprises a stage upstream of the at least one interleaving stage, preferably upstream of the at least two, and more preferably at least three, interleaving stages, comprising multiplexing devices comprising, preferably each, a dichroic filter configured to combine two light beams having a mutually distinct wavelength.

Preferably, when the stage upstream of the at least one interleaving stage comprises dichroic filters, the two beams combined by the dichroic filter have the same polarization. The wavelengths combined in this stage correspond to the first multiplexing level. The wavelengths considered are at this level separated by several channels. Preferably, the wavelengths combined by a dichroic filter are separated by a frequency of at least 500 GHz. It is thus possible to use dichroic filters despite their drawbacks above. Preferably, each beam has a single wavelength at the input of the dichroic filter. The embodiment of the dichroic filter is thus simplified.

According to one example, the successive multiplexing device stages are arranged at least in part in the same plane.

According to one example, the successive multiplexing device stages are disposed in the same plane. Preferably, all of the multiplexing devices of the successive stages are disposed in the same plane. The system thus has a flat architecture which can be readily incorporated into a space terminal.

According to one example, for at least one stage, the multiplexing devices are disposed in distinct planes, for example, at least two multiplexing devices are superposed. The system thus has an arrangement on several levels of the interleaving stages. Its dimensions can therefore be reduced. It is therefore understood that the architecture of the multiplexing system can be modulated according to available space constraints, which is often required for space terminals. Preferably, for at least one stage, the multiplexing devices are at least in part, and preferably all, disposed in distinct planes. For example, all the multiplexing devices of this stage are superposed.

According to one example, at least the first stage, or equivalently the most upstream stage(s), is (are) disposed in a main extension plane distinct from the main extension plane of the subsequent stages, so as to minimize the size. This number of upstream stages may be less than or equal to 3. This is particularly adapted for multiplexing a large number of beams, and particularly from 20 beams to be combined.

According to one example, the multiplexing system comprises collimator modules configured to emit the at least four polarized light beams to be multiplexed in free space, the collimator modules comprising adjustment mechanisms configured to adjust the position and orientation of the at least four light beams. The position and orientation of the light beams may be adjusted at the collimator module. Synergistically with the angle invariance of at least the combination module, and preferably also the transformation modules, the optical path of the beams remains robust to thermal or mechanical stress on the multiplexing system, and the optical performance of the multiplexing is not affected.

According to one example, the multiplexing system comprises collimator modules configured to emit the at least four polarized light beams in free space, and the method further comprises adjusting the position and/or orientation of the at least four polarized light beams to be multiplexed at the collimator modules.

According to one example, the multiplexed beam output from the multiplexing system is transferred in free space to a telescope for its emission.

According to one example, the telescope is a space satellite telescope.

According to one example, the power of at least one beam, and preferably each beam, upstream of the optical multiplexing devices is between 5 W and 50 W.

According to one example, the power of the output beam of the multiplexing system is between 20 W and 1000 W.

Hereinafter in the following description, the term “on” does not necessarily mean “directly on”. Thus, when it is stated that a part or a member A is bearing “on” a part or a member B, this does not mean that the parts or members A and B are necessarily in direct contact with each other. These parts or members A and B may either be in direct contact or bearing on each other via one or more other parts.

In the present patent application, when it is stated that two parts are distinct, this means that these parts are separate. They may be:
positioned at a distance from each other, and/or
movable relative to each other and/or
secured to each other by being attached by mounted elements, this attachment being optionally removable.

A one-piece unitary part therefore cannot be formed of two distinct parts.

In the present patent application, the term “secured” used to describe the connection between two parts means that the two parts are connected/attached to each other, in all degrees of freedom, unless explicitly stated otherwise. For example, if it is stated that two parts are secured in translation in a direction x, this means that the parts may be movable relative to each other, possibly in several degrees of freedom, excluding freedom in translation in the direction x. In other words, if one part is moved in the direction x, the other part performs the same movement.

In the following detailed description, terms such as “horizontal”, “vertical”, “longitudinal”, “transverse”, “upper”, “lower”, “up”, “down”, “upstream”, and “downstream” may be used. These terms must be interpreted relatively in relation to the normal position of the multiplexing system and the propagation of the light beams in this system. For example, an “upstream” element is an element of the system placed before another so-called “downstream” element in the direction of propagation of the light beams in the system. The direction of propagation of the light beams in the multiplexing system is considered to start from the side of the plurality of beams to be multiplexed and to move in the direction of the output multiplexed beam.

A reference frame shall also be used, of which the longitudinal or forward/backward direction corresponds to the axis x, the transverse or left/right direction corresponds to the axis y, and the vertical or up/down direction corresponding to the axis z.

In the field of telecommunications, free space optics (FSO) communications are communications using light propagation in free space, in order to transmit data between two remote points. This technology is of interest when a physical connection via cable or optical fiber is unsuitable, for example for transmission between low and very high altitude, and spatial transmissions. “Free space” means any signal-carrying spatial medium such as air, interstellar medium, vacuum, as opposed to a material transport medium, such as optical fiber or wired or coaxial transmission lines.

The multiplexing system 1, the emission assembly 2 and the multiplexing method are now described according to several exemplary embodiments.

As illustrated in FIG. 3, for example, the multiplexing system 1 is configured to multiplex at least four polarized light beams into one multiplexed beam 12 for transmission in free space.

The emission assembly 2 comprises the multiplexing system 1 and a telescope 20. The system 1 can be more particularly placed between fiber sources, for example laser sources, transporting the data stream to be sent, and the telescope 20. The emission assembly 2 may comprise the fiber sources of the beams 10. The system 1 may comprise the fiber sources. Each beam may be obtained from a fiber source, there may therefore be at least four fiber sources.

The various aspects of the invention are adapted for space applications, particularly for links between LEO orbits and the ground, MEO and the ground, GEO and the ground, but also between satellites in the same orbit or in different LEO, MEO, or GEO orbits. Transmission between low and high altitude, hereinafter referred to as high-altitude transmission, is also an envisaged application. By way of example, the lowest orbits are at an altitude of 400 km (LEO). The highest are at 36,000km (GEO). Inter-satellite distances for so-called ISL (Inter-Satellite Link) links are typically from 100 km to 500 km. The various aspects of the invention are particularly adapted for long-distance transmission of a beam in free space, for example over a distance between 100 km and 36,000km. Note that for transmission between low and high altitude, the distance for beam transmission may be between 20 km and 50 km, between a valley and a mountain, for example. The power of the emitted beam 12 is, however, generally lower than for space applications. The telescope 20 of the emission assembly 2 may therefore be a satellite telescope or a ground station telescope. The various aspects of the invention are more particularly intended for the emission of multiplexed signals, rather than for the reception of multiplexed signals. Indeed, the problems of high beam power are rather linked with the emission of a multiplexed signal to be transmitted over long distances, as described hereinafter. In reception, the power received being lower, existing fiber solutions may be used.

For space transmission and high-altitude transmission applications, several fiber sources emit polarized light beams 10 in free space. These beams 10 are multiplexed and transmitted in free space to the telescope 20. Due to the multiplexing of multiple beams 10, and the distance to be traveled before reception of the multiplexed beam 12, the beams 10 and more particularly the multiplexed beam 12 have a high optical power. The optical power of the beams 10 to be multiplexed, upstream of the multiplexing system 1, is for example greater than or equal to 5 W, preferably between 5 W and 50 W. The optical power of the multiplexed beam 12, output from the multiplexing system 1, is for example greater than or equal to 20 W, preferably between 20 W and 1000 W. In view of the power to be transported, the beams 10 have a diameter greater than the diameter generally used for terrestrial applications (typically in the order of 200 μm to 300 μm in diameter). For example, the beams 10 and the multiplexed beam 12 may have a diameter in the order of a millimeter, for example greater than or equal to 0.5 mm, for example between 0.5 mm and 20 mm. The multiplexing devices 11 of the system 1, and particularly the optical elements composing them, may therefore have dimensions such that they are capable of being crossed or capable of acting on light beams of this diameter.

The optical power transported by the different beams does not allow the use of conventional fiber components, for example those used in terrestrial telecommunication applications. The multiplexing and transmission of the multiplexed beam 12 are therefore constructed in free space.

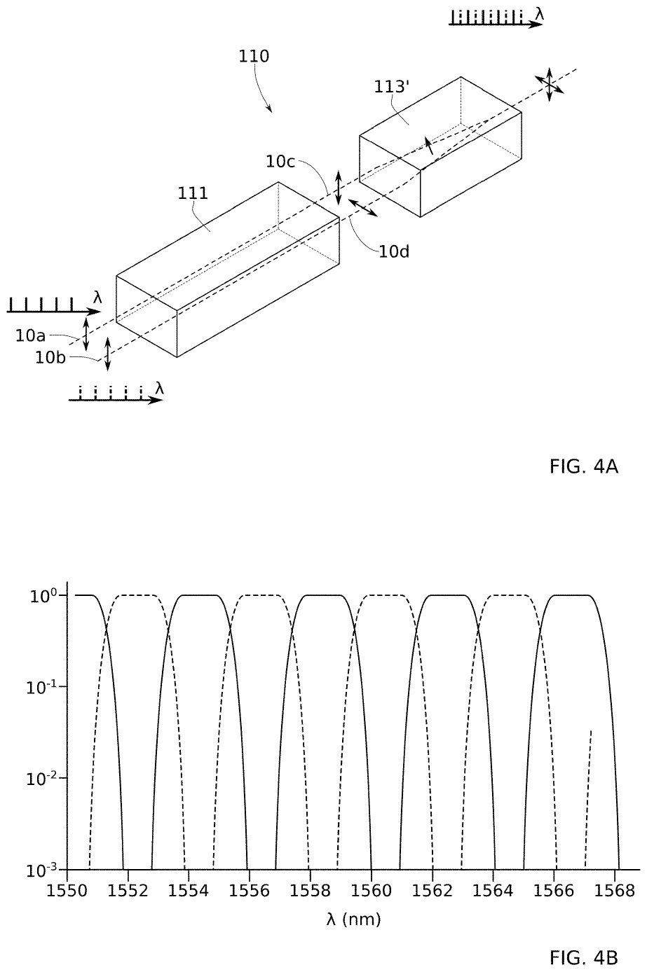

The system 1 can particularly be configured to successively combine these beams 10 pairwise. For this purpose, the system 1 comprises a plurality of optical multiplexing devices 11. These multiplexing devices 11 are arranged in a plurality of stages 11a, 11b allowing the successive multiplexing of these beams 10. Among the stages of the system 1, the system 1 comprises at least one interleaving stage 11b, comprising at least one interleaving device 110 configured to combine two beams 10a and 10b by interleaving. The principle of interleaved multiplexing is first described with reference to FIGS. 4A and 4B, according to an existing solution used for terrestrial applications for low-power beams, with conventional diameters of about 300 μm. An interleaving device 110 may comprise an optical transformation module 111 and a combination module 113′. Two incoming beams 10a and 10b, comprising for example several wavelengths, referred to as wavelength series, are handled by the optical transformation module 111. The wavelengths are different between the two beams 10a, 10b. In this example, both beams 10 have the same polarization. The transformation module 111 is configured to modify the polarization of one of the two incoming beams 10a, 10b to create two outgoing beams 10c, 10d of mutually distinct polarization. For thus purpose, the transformation module 111 may for example generate a wave plate law for one wavelength series and a half-wave plate law for the other. At the output, the outgoing beams 10c and 10d may therefore have cross-polarization. It is then possible to combine them with the combination module 113′. The combiner 113′, generally a crystal, is however not well-suited to high-power beams, because a very long crystal is necessary to accommodate beams of substantial diameter. A crystal having the appropriate size would be difficult to source, have a high cost, and would have unacceptable absorption of the beams passing through it.

FIG. 4B illustrates by way of example the wavelength response of the interleaving device illustrated in FIG. 4A. Unlike existing solutions implementing dichroic filters, with an interleaving device 110, a transition zone is no longer observed. Interleaving therefore makes it possible to combine wavelengths that are very close to each other by optimizing the bandwidth.

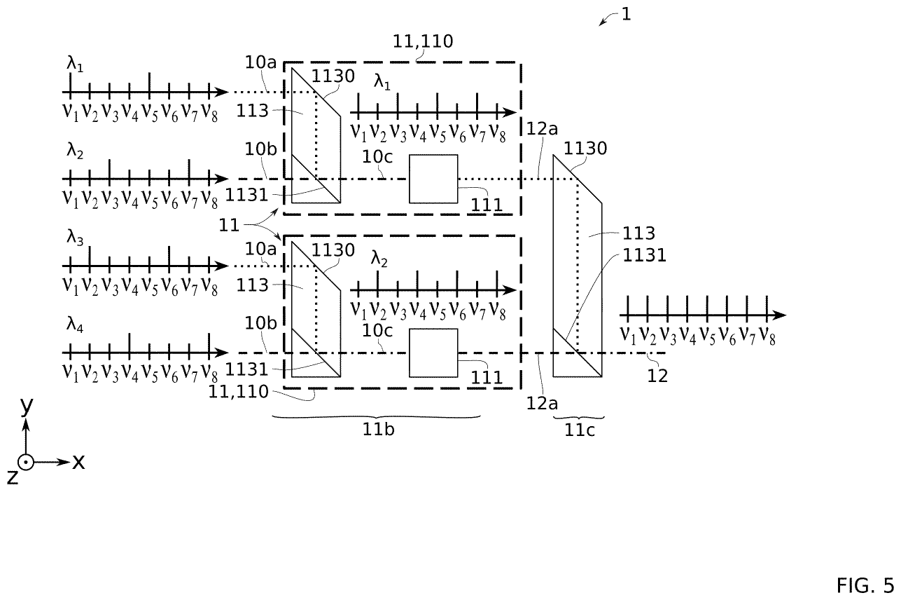

The operating principle of the multiplexing system 1 is firstly described with reference to FIG. 5. The system 1 may comprise at least two stages 11b and 11c, at least one stage being an interleaving stage 11b.

The interleaving stage 11b comprises at least one interleaving device 110, for example illustrated in FIG. 5 by the dotted line box. The interleaving device 110 is configured to receive a first incoming beam 10a and a second incoming beam 10b. The first incoming beam 10a may have at least a first wavelength λ₁, and the second incoming beam 10b may have at least a second wavelength λ₂, distinct from the at least a first wavelength λ₁. Each beam 10a and 10b may carry a wavelength series, the wavelength series being distinct between the two beams 10a, 10b. Hereinafter, the term “wavelength” may mean a single wavelength or a wavelength series. The incoming beams 10a and 10b furthermore have a distinct polarization at the input of the interleaving device 110. The term “distinct polarization” means that the polarization states between two beams are different.

The interleaving device 110 is configured to combine the incoming beams 10a, 10b to form a combined beam 10c, having a different polarization according to the wavelengths it carries. The polarization of the outgoing beam 10c is therefore mixed, since the wavelengths from the first beam 10a have one polarization state, and the wavelengths from the second beam 10b have a distinct polarization state. The interleaving device 110 is then configured to modify the beam 10c such that the different lengths have the same polarization.

For this purpose, the interleaving device 110 comprises an angle-invariant optical combination module 113. The incoming beams 10a and 10b of distinct polarization are combined by the optical combination module 113 to form the combined beam 10c output from the combination module 113.

The interleaving device 110 further comprises an optical transformation module 111. The transformation module 111 is configured to receive the beam 10c from the combination module 113. The transformation module 111 is configured to modify the polarization of the first wavelength λ₁ or of the second wavelength λ₂ of the beam 10c, in order to form a beam 12a having the same polarization for the wavelengths it carries.

For example, as illustrated in FIG. 5, the first incoming beam 10a may have odd wavelengths λ₁. The second incoming beam 10b may have even wavelengths λ₂, and a distinct polarization from the first beam 10a. The beams 10a and 10b are then combined by the combination module 113 while retaining their polarization in order to form the beam 10c. When passing through the transformation module 111, the polarization of the even or odd wavelengths of the beam 10c may be modified to obtain the beam 12a. The wavelengths λ₁, λ₂ of the beam 12a then have the same polarization.

The combination module 113 is angle-invariant. A change in orientation or a torsion will not cause significant deviation of the light beams. This may particularly arise due to thermal and/or mechanical stress on the multiplexing system. These types of stress are indeed common for space and high-altitude applications. For example, a difference in sunshine may cause substantial thermal variations on the multiplexing system 1, capable of affecting its stability. The angle invariance at least of the combination module 113 makes it possible to minimize these phenomena. Furthermore, the effect of a position adjustment fault of the combination module is limited.

In order to obtain angular invariance, a person skilled in the art is capable of identifying which optical elements to use. For example, as illustrated in FIG. 5, the combination module 113 has a first surface 1130 and a second surface 1131 parallel to each other. The first surface 1130 may more particularly be disposed on the optical path of the incoming beam 10a. The second surface 1131 may more particularly be disposed on the optical path of the incoming beam 10b. The first surface 1130 may be configured to reflect the first incoming beam 10a and the second surface 1131 may be configured to reflect the first incoming beam 10a from the reflection on the first surface 1130. The second surface 1131 may be configured to allow the second incoming beam 10b to pass. The surfaces 1130, 1131 of the combination module 113 may reflect or transmit a beam according to its polarization state. The beams 10a and 10b having distinct polarizations, the first beam 10a may be reflected on the surfaces 1130 and 1131, whereas the second beam 10b is transmitted by the second surface 1131. According to a preferred example, TE polarization (or s polarization) is reflected on the surfaces 1130, 1131 and TM polarization (or p polarization) is transmitted by the surface 1131. The optical processing of the surfaces 1130, 1131 is more effective in this configuration. Note that it is nonetheless possible to provide that TE polarization (or s polarization) is transmitted by the surface 1131, and TM polarization (or p polarization) is reflected by the surfaces 1130 and 1131.

Through the successive reflection of the incoming beam 10a on the surfaces 1130 and 1131, this beam is placed on the same optical path as the incoming beam 10b. The beams 10a and 10b are thus combined by an angle-invariant optical element. According to one particular example, the combination module is an optical rhombohedron. Preferably, the optical transformation module 111 is a birefringent module. Each module may for example comprise a birefringent crystal. Thus, the optical transformation module is also angle-invariant. The robustness of the system is thus further enhanced, as is its adjustment fault tolerance. This makes it even easier to handle large-sized beams, the angular sensitivity of which is particularly high, as seen above.

During system assembly, the birefringent modules 111 are preferably oriented to adjust the thickness crossed by the beam. This thickness may vary the position of the spectral response. In order to align the response of the birefringent modules precisely on the desired wavelength grid, it is possible to modify the orientation of the birefringent modules, for example via adjustment members not shown in the figures. This operation is simple and allows a quick alignment of the system 1.

As an alternative to birefringent modules, other types of transformation modules 111 may be considered, such as Michelson-Gires-Tournoi or Mach-Zehnder-Gires-Tournoi type modules. However, these modules may prove to be more complex to implement in the system 1 and/or not have angle invariance.

For the same stage 11b, the system 1 may comprise several multiplexing devices 11, and particularly several interleaving devices 110. As illustrated in FIG. 5, a second interleaving device 110 may be configured to multiplex two beams 10a, 10b of wavelengths λ₃, λ₄, as explained above.

The multiplexing system 1 may further comprise a stage 11c comprising an optical combination module 113 as described above, for example an optical rhombohedron. For this purpose, two interleaving devices 110 of a stage 11b may be configured to form two beams 12a of mutually distinct polarization. In particular, the optical transformation modules 111 may be configured in relation to each other in order to form a beam 12a having one polarization, and a beam 12a having a second polarization. For this purpose, either the transformation modules may be mutually distinct, as described hereinafter, or the wavelengths of the 10c beams may give different polarization states. For example, in FIG. 5, odd wavelengths will give a first polarization state after passing in the transformation module 111 of a first device 110, and even wavelengths will give a second polarization state after passing in the transformation module 111 of a second device 110, identical to the transformation module 111 of the first device 110. In this embodiment, and when the transformation modules 111 are birefringent modules. All the optical elements of the system 1 may be angle-invariant.

The multiplexing system 1 therefore allows multiplexing of a substantial number of light beams 10 (and in particular at least four beams 10) compared to existing solutions, in a robust and reliable manner while maximizing bandwidth.

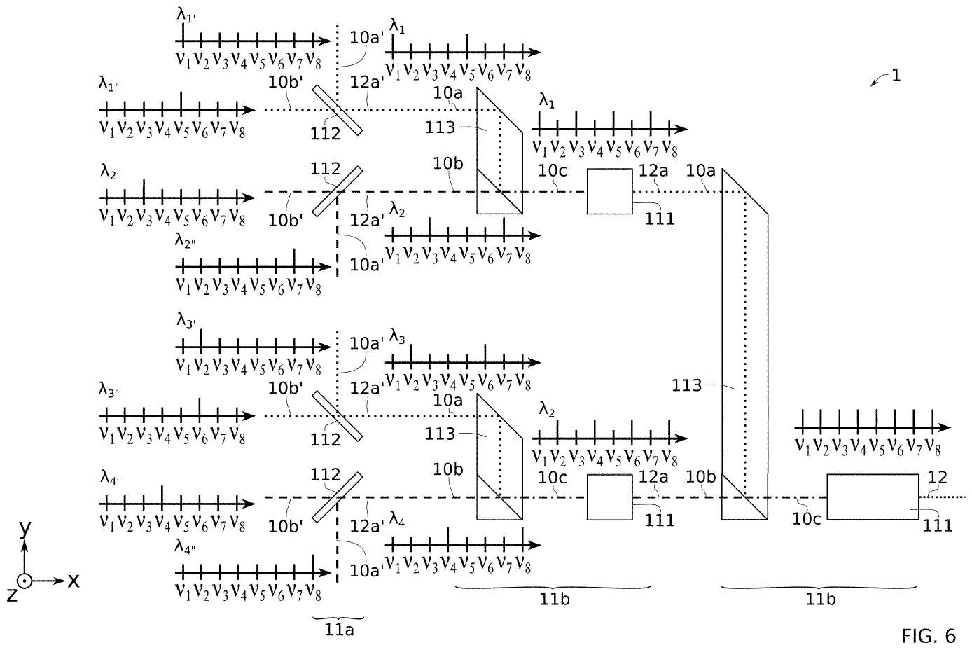

The multiplexing system 1 may comprise a plurality of successive stages 11b, or 11c, to combine the beams 10 pairwise. The number of beams that can be multiplexed by the multiplexing system 1 is not limited to a given number of beams 10. According to the number of stages 11a, 11b, 11c and the number of multiplexing devices 11 per stage, it is understood that the architecture of the multiplexing system 1 may be adapted. For example, in one stage, 2N beams may be combined into N beams by N multiplexing devices 11. The multiplexing system 1 may comprise N stages. Preferably, and as will be described in more detail hereinafter, the system may comprise at least three, and preferably at least four, and more preferably at least five stages. These at least two and preferably at least three stages include interleaving stages 11b, preferably successive. As shown in FIG. 6, at least one stage 11a located upstream of the interleaving stage(s) 11b may comprise multiplexing devices 11 comprising a dichroic filter 112. This multiplexing device 11 may be configured to combine two beams 10a′, 10b′ to form a single beam 12a′. This beam 12a′ may then be an incoming beam 10a or 10b in a subsequent multiplexing device 11, and more particularly an interleaving device 110.

A dichroic filter 112 may be configured to combine two light beams, these two light beams having a distinct wavelength and preferably the same polarization. FIG. 6 illustrates, by way of example, a first stage 11a comprising dichroic filters 112. Preferably, when the stage 11a comprises dichroic filters, the two beams combined by the dichroic filter 112 each have a single wavelength. It is indeed simpler to design dichroic filters having a wavelength range reflected on the filter 112 and a wavelength range transmitted by the filter 112. This example is particularly adapted when each source fiber only supplies a single wavelength.

Preferably, the wavelengths of the beams are then at least 500 GHz apart, in order to accommodate the transition zone of the dichroic filter 112. For an upstream stage, and particularly for the first stage of the system 1, the wavelengths to be combined are still far apart. It is therefore possible to use dichroic filters without being impacted by the associated stress.

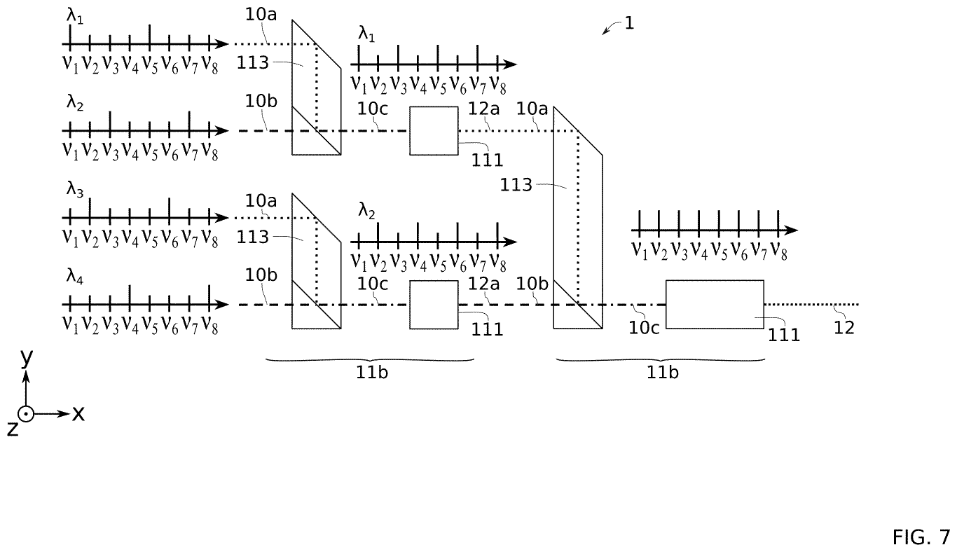

The downstream stage 11c may be an interleaving stage, comprising an interleaving device equipped with a combination module and a transformation module 111, as illustrated in FIGS. 6 and 7. The combination module 111 output from the system 1 may more particularly be configured to rectify the polarization of the beam 10c output from the combination module 113. This transformation module 111 may be a birefringent module as described above. Indeed, the combination module 113 combining beams with distinct polarizations, the beam 10c has two polarization states. Preferably, the transformation module 111 is disposed at the output from the last combination module 113 downstream of the system 1, as illustrated by FIG. 7. The transformation module 111 may therefore receive the beam 10c to form a multiplexed beam 12 of homogeneous polarization.

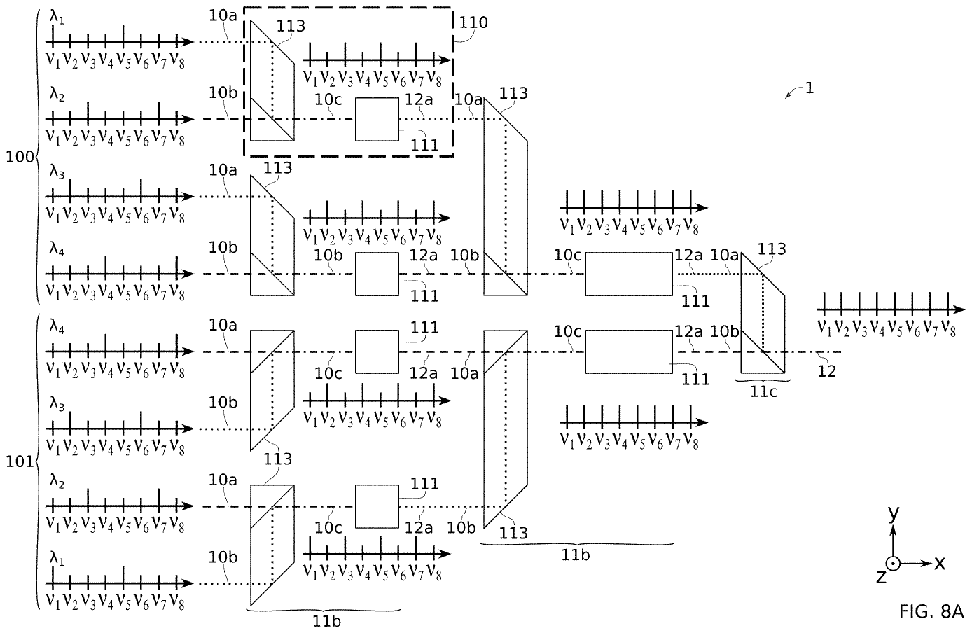

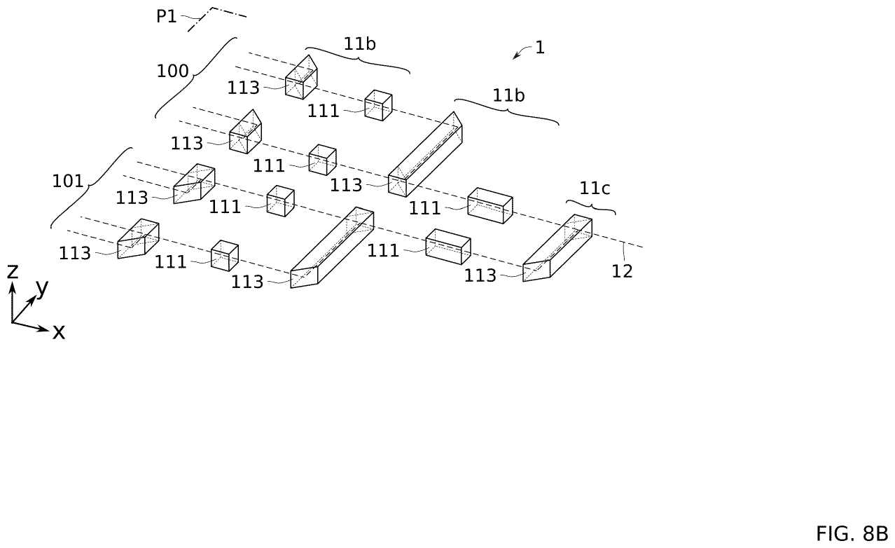

The system 1 may comprise several interleaving stages 11b, optionally combined with the variants described above. FIG. 8A illustrates, by way of example, a system 1 comprising two interleaving stages 11b, with a downstream stage 11c comprising a combination module 113. Preferably, each multiplexing device 11 of an interleaving stage 11b is an interleaving device 110.

In the light of the figures, it is understood that the multiplexed beam 12a output from an interlacing device 110 may form the incoming beam 10a or 10b for a subsequent interleaving device 110. The signal output from the last multiplexing device 11 downstream of the system 1 may form the multiplexed beam 12.

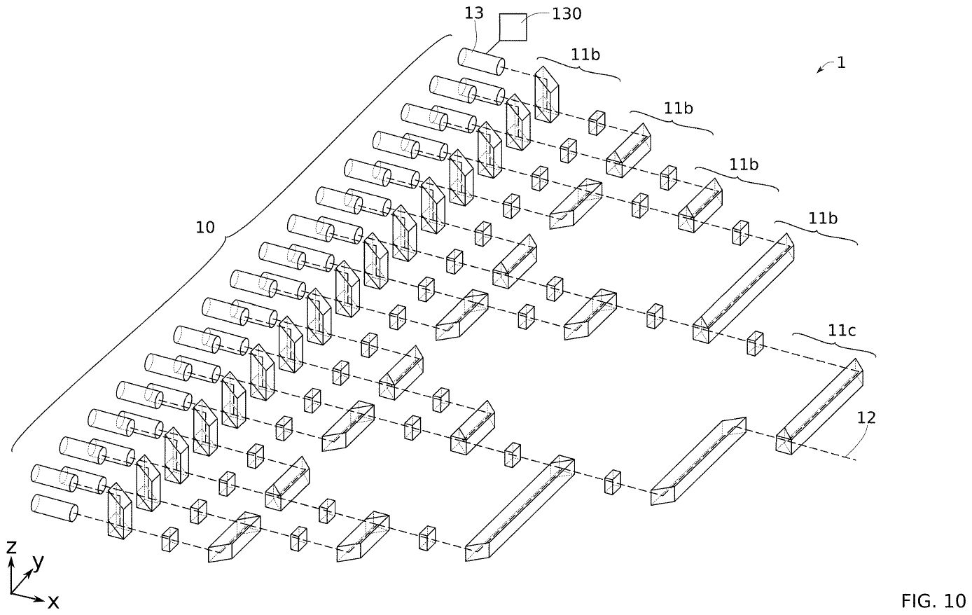

As illustrated for example in FIG. 10, the emission signal may be supplied in free space to the system 1 by one or more series of optical fibers, for example via collimator modules 13 (illustrated for example in FIG. 10). As illustrated for example in FIG. 8A, each series may transport the same wavelengths, for example λ₁ to λ₄, with different polarization states between the series, for example an s polarization and a p polarization. Within each series, each fiber may transport a beam having one or more wavelengths, for example two wavelengths.

To orient the beams 10, due to the angular invariance of all or part of the optical elements of the system 1, this function may be carried out by the collimator modules 13. For this purpose, the collimator modules may comprise adjustment members 130. In FIG. 10, these members 130 are shown schematically for a single collimator 13, in order to simplify the figure. The adjustment members 130 are configured to adjust the geometric parameters of the incoming beams 10 of the system 1. This adjustment of the geometric parameters of the beams 10 makes it possible to compensate for any faults in the various optical components of the system. Manufacturing tolerances are thus more readily accommodated by the system 1.

As illustrated by FIG. 8A, the system may comprise a first arm 100, equivalently a first part, configured to successively combine the beams from the first series of fibers, and a second arm 101 configured to successively combine the beams from the second series of fibers. The arms 100, 1001 may be mirrors of each other. For example, the polarizations of the beams 10a λ₁ of the arms 100 and 101 are identical, as well as for the other wavelengths λ₂ to λ₄.

An interleaving stage 11c may combine downstream the multiplexed beams 12a from each arm 100, 101. In the example illustrated, it is sought to combine the two identical wavelength trains by polarization. This implies that the transformation modules 111 of the previous stage 11b are configured to output a different polarization state between the two beams 12a. The last stage 11c then does not comprise a transformation module 111. Indeed, the multiplexed beam 12 formed here comprises two times each of the wavelengths, in different polarization states. It is therefore unnecessary to rectify the polarization because it is sought to obtain a multiplexed beam 12 of non-homogeneous polarization.

The architecture of the interleaving devices 110 and the angle invariance at least of the combination module 113 allow a modular arrangement of these devices to adapt the architecture of the system 1 according to needs. This is of particularly interest for space applications, for which space constraints may be substantial in on-board devices on space terminals.

Several architectures are now described with reference to FIGS. 8B to 10. These architectures are described by way of example and may be combined with the variants described above. Furthermore, other architectures may be considered, for example according to constraints in respect of space and/or the number of beams 10 to be multiplexed. In these figures, the polarization differences between the beams are not shown in order to simplify the figures.

As illustrated for example in FIG. 8B, the successive stages 11b and 11c of multiplexing devices 11 may be disposed at least in part in the same plane P1.

Preferably, according to one embodiment, all of the multiplexing devices of the successive stages are disposed in the same plane P1. The system 1 then has a smaller size in the vertical dimension z. The system 1 has a flat architecture which can be readily incorporated into a space terminal.

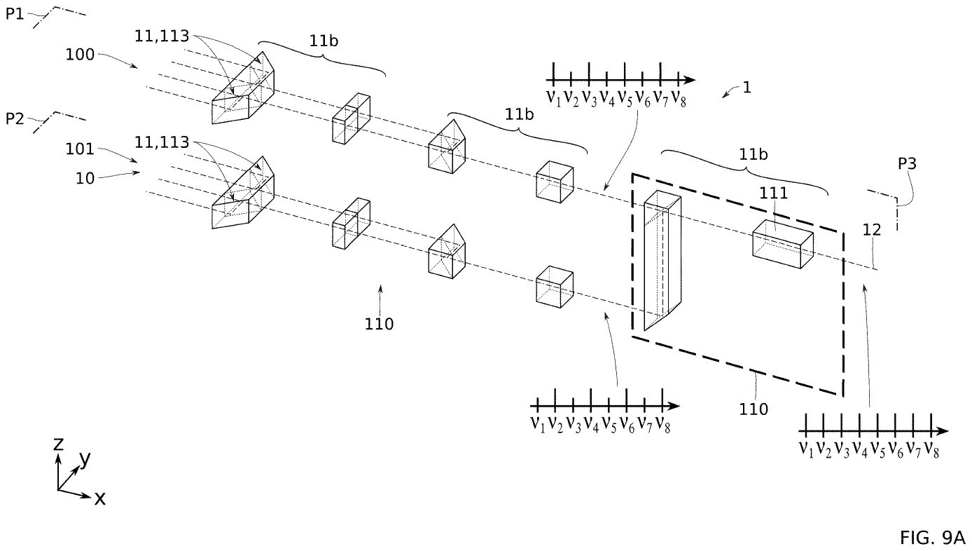

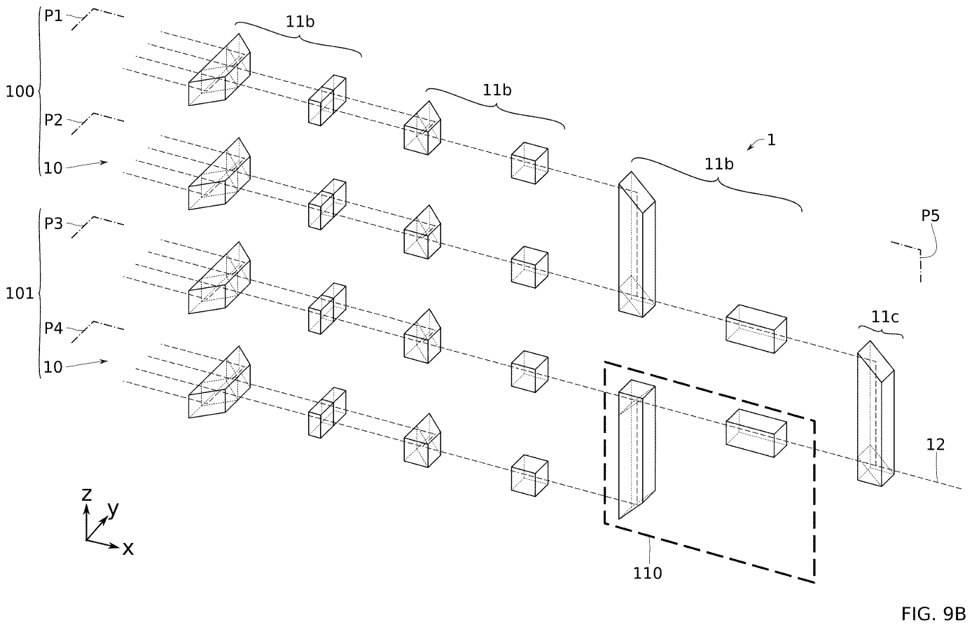

According to another example, for at least one stage 11b, the multiplexing devices may be disposed in distinct main extension planes P1 and P2. The main extension plane for a multiplexing device 11 is considered to be the plane formed by the beams as they propagate and are combined in this device. As illustrated for example in FIG. 9A, the first arm 100 may be disposed in the plane P1, and the second arm 101 may be disposed in the plane P2 parallel to P1, these planes being for example disposed horizontally. The interleaving module 110, combining the beams from these two arms 100 and 101, may be disposed in a plane P3 perpendicular to the plane P1 and P2, for example vertically. According to the number of beams 10 to be multiplexed, this architecture may be adapted. FIG. 9B illustrates for example a four-level architecture wherein the multiplexing devices 11 are disposed in four parallel planes P1 to P4. The beams 10 are then combined by two stages 11b and 11c placed in a perpendicular plane P5.

It is therefore understood that the size of the system 1 in one and/or the other or each direction x, y, z may be adjusted according to needs.

The transformation modules 111 and/or the combination modules 113 may be disposed according to the size constraints of the system 1, for example, they may be juxtaposed, optionally in a secured manner.

The architecture of the system 1 may furthermore be adapted according to the number of beams to be multiplexed. By way of example, FIG. 10 illustrates a system 1 configured to multiplex two times sixteen beams 10 with two polarizations. In this example, each beam only transports a single wavelength. Therefore, there are a total of 32 inputs. The system comprises a stage 11a comprising optical rhombohedra and four interleaving stages 11b. The fact that the optical components are all angle-invariant here simplifies the construction of the system compared to existing solutions.

In this example, the system 1 comprises 32 collimator modules 13, one per emitted beam. In this example, the first stage 11b is vertical whereas the others are horizontal. This makes it possible to place the 32 collimator modules on two levels, and thus limit the size in the direction y.

According to one example not illustrated, the combination modules 113 may comprise adjustment mechanisms for adjusting their position. Due to the reflection on the surfaces 1130 and 1131, it is understood that a movement of a combination module allows an adjustment of the beam position. However, a change in orientation of the combination module 113, as seen above, does not modify the beam orientation.

Preferably, the optical elements at least of the interleaving devices 110, and preferably of all the multiplexing devices 11, are based on crystalline materials. Preferably, the crystalline materials are chosen such that their thermal behavior is compensated between them when they are subjected to a thermal variation. Using crystalline materials indeed makes it possible to combine materials for which the thermal behaviors are compensates so that the assembly is athermal.

According to one example, the optical elements of at least the interleaving devices 110, and preferably of all the multiplexing devices 11, are based on materials resistant to solar radiation. In the light of the available knowledge on materials resistant to solar radiation and/or having appropriate properties for space applications, a person skilled in the art is capable of choosing which materials to use in the system 1. The combination module 113 may for example be made of glass.

On reading the description above, the multiplexing system 1 and/or the emission assembly 2 may therefore be used in a free-space multiplexing method of polarized light beams 10. The method may comprise any step resulting from the implementation of the features of the system 1 as described above.

In the light of the description above, it is clear that the invention provides an enhanced solution for multiplexing at least four light beams for transmission of a light beam in free space.

The invention is not limited to the embodiments previously described and extends to all the embodiments covered by the invention. The present invention is not limited to the examples described above. Many other alternative embodiments are possible, for example by combination of features described above, without going beyond the context of the invention. For example, according to the polarization state of the incoming beams and their wavelength, a person skilled in the art may adapt the architecture of the system 1 described. Note that other elements may be added to the system 1, for example photodiodes or light wells for managing light leaks. Moreover, the features described relative to one aspect of the invention can be combined with another aspect of the invention.

1. A free-space multiplexing system of at least four polarized light beams for the transmission of a multiplexed beam in free space to a telescope, the system comprising a plurality of optical multiplexing devices wherein the optical multiplexing devices are arranged in at least two successive stages to successively combine said polarized light beams pairwise in free space, and wherein, for at least one stage, referred to as “interleaving stage,” at least one multiplexing device comprises an interleaving device configured to receive a first incoming beam having at least a first wavelength and a second incoming beam having at least a second wavelength distinct from the at least a first wavelength, the first incoming beam and the second incoming beam having mutually distinct polarizations, the interleaving device comprising:
an angle-invariant combination optical module configured to combine the first and second incoming beams so as to form an outgoing beam of mixed polarization,
an optical transformation module configured to receive the outgoing beam, the transformation module being configured so as to modify the polarization of one among the at least a first wavelength and the at least a second wavelength, so as to form a multiplexed beam wherein the at least a first and at least a second wavelengths have a same polarization, and
wherein the optical multiplexing devices are configured for light beams having a diameter greater than or equal to 0.5 mm.

2. The system according to claim 1, wherein the optical transformation module is a birefringent module.

3. The system according to claim 1, wherein the angle-invariant combination optical module comprises a first surface and a second surface parallel to each other, the first surface being configured to reflect the first incoming beam and the second surface being configured to reflect the first incoming beam resulting from the reflection on the first surface, and allow the second incoming beam to pass so as to combine the first incoming beam and the second incoming beam.

4. The system according to claim 1, wherein the optical multiplexing devices are configured for light beams having a diameter in the order of a millimeter.

5. The system according to claim 1, comprising at least two, successive interleaving stages.

6. The system according to claim 1, comprising a stage upstream of the at least one interleaving stage, comprising multiplexing devices comprising a dichroic filter configured to combine two light beams having a mutually distinct wavelength, and having the same polarization.

7. The system according to claim 1, wherein the successive stages of multiplexing devices are disposed in a same plane.

8. The system according to claim 1 wherein, for at least one stage, the multiplexing devices are disposed in distinct planes.

9. The system according to claim 1, comprising collimator modules configured to emit in free space the at least four polarized light beams to be multiplexed, the collimator modules comprising adjustment members configured to adjust a position and orientation of the at least four light beams.

10. A telescope emission assembly comprising the multiplexing system according to claim 1 and a telescope.

11. The telescope emission assembly according to the claim 10, configured to transmit the multiplexed beam output from the multiplexing system in free space to the telescope.

12. The telescope emission assembly according to claim 10, wherein the telescope is a space satellite telescope.

13. A free-space multiplexing method for the transmission of a multiplexed beam in free space by a telescope, comprising:
receiving at least four polarized light beams in free space, said beams having a diameter greater than or equal to 0.5 mm,
passing said light beams in a multiplexing system comprising a plurality of optical multiplexing devices arranged in at least two successive stages so as to successively combine said light beams pairwise in free space, at least one multiplexing device of at least one stage, referred to as “interleaving stage,” comprising an interleaving device comprising an optical transformation module, and an angle-invariant optical combination module, such that:
a first incoming beam, having at least a first wavelength, and a second incoming beam, having at least a second wavelength distinct from the at least a first wavelength, the first incoming beam and the second incoming beam having mutually distinct polarizations, are received and combined by the optical combination module, so as to form an outgoing beam of mixed polarization,
the outgoing beam received by the optical transformation module, and the polarization of one among the at least a first wavelength and at least a second wavelength is modified by the transformation module, so as to form a multiplexed beam wherein the at least a first and at least a second wavelengths have a same polarization, and
a transfer in free space to a telescope of the multiplexed beam output from the multiplexing system, the multiplexed beam having a diameter greater than or equal to 0.5 mm.

14. The method according to claim 13, wherein the multiplexing system comprising comprises collimator modules configured to emit at least four polarized light beams in free space, the method further comprises adjusting, at the collimator modules, a position and/or orientation of the at least four polarized light beams to be multiplexed.

15. The method according to claim 13, wherein the multiplexed beam output from the multiplexing system has a power between 1 W and 1000 W.
